(19) United States
(12) Patent Application Publication
(10) Pub. No.: US 2012/0326811 A1
(43) Pub. Date: Dec. 27, 2012

(54) Temperature-Independent Dielectric Resonator

(75) Inventors: Giuseppe Resnati, Seregno (IT); Roberto Foglieni, Bottanuco (BG) (IT); Antonio Sala, Agrate Brianza (IT); Massimo Rivolta, Agrate Brianza (IT); Filippo Imperatore, Medolago (IT)

(73) Assignee: COMMSCOPE ITALY S.R.L, Agrate Brianza (IT)

(21) Appl. No.: 13/192,778

(22) Filed: Jul. 28, 2011

(30) Foreign Application Priority Data
Jun. 24, 2011 (EP) 11425165.5

(51) Int. Cl. H01P 7/10

(52) U.S. Cl. 333/234

(57) ABSTRACT

A (TM01) dielectric resonator has a metal housing, a dielectric insert, and a resilient element located between one end of the dielectric insert and the housing. The resilient element ensures physical contact between the housing and both ends of the dielectric insert over the entire operating temperature range of the resonator, thereby compensating for differences in the coefficients of thermal expansion of the materials used for the metal housing and the dielectric insert. In one embodiment, the dielectric insert is housed within a cylindrical tube between a top cover and a bottom end cap, the resilient element is an electrically non-conductive (silicone rubber) gasket, and the resonator has a thin, electrically conductive (aluminum) plate located (i) between the dielectric insert and the gasket and (ii) between the end cap and the tube to ensure a contiguous electrically conductive path from one end of the dielectric insert to the other.

### BACKGROUND

1. Field of the Invention

The present invention relates to electronics and, more specifically but not exclusively, to dielectric resonators, such as TM01 dielectric resonators, used in RF filters.

2. Description of the Related Art

This section introduces aspects that may help facilitate a better understanding of the invention. Accordingly, the statements of this section are to be read in this light and are not to be understood as admissions about what is prior art or what is not prior art.

A dielectric resonator (DR) filter is a type of radio frequency (RF) filter that has a dielectric resonator that resonates at an RF or ultra RF frequency. Dielectric resonators can be categorized into TM (transverse magnetic), TEM (transverse electro magnetic), and TE (transverse electric) mode resonators depending on their structure, which determines their resonant mode.

FIG. 1 shows a cross-sectional side view of a conventional TM-mode dielectric resonator 100. Resonator 100 includes an electrically conductive (e.g., metal such as aluminum) housing consisting of a cylindrical container 102 and a circular cover 104, configured with two electrical connectors 106, where cover 104 is held in place on the top of container 102 by a number of screws 108. Positioned within resonator 100 is a hollow, cylindrical dielectric insert 110, which is centered within resonator 100 using a cylindrical guide pin 112 located at the bottom of container 102. Tuning screw 114 is used to tune the resonant frequency of resonator 100. Note that the outer diameter of dielectric insert 110 is smaller than the inner diameter of cylindrical container 102, such that resonator 100 has a cylindrical, annular gap 116 between insert 110 and container 102.

In order to operate with a sufficiently high Q factor in the desired TM resonant mode (e.g., the first resonant mode TM01), with a reduced resonator height to achieve low-profile filter packages, dielectric insert 110 should be in physical contact with both cover 104 and the bottom of container 102, such that a contiguous, electrically conductive path is provided from the bottom of the dielectric insert to the top of the dielectric insert via container 102 and cover 104. It is also desirable for resonator 100 to operate in the desired TM resonant mode over a wide range of operating temperatures (e.g., from −40 C to +85 C). Unfortunately, the materials typically used for the metal housing (e.g., aluminum) and the dielectric insert (e.g., conventional ceramic materials with dielectric constants varying from about 20 to about 80 such as barium titanate, BaLnTi oxide, BaZnToTi oxide, and BaTi oxide) have coefficients of thermal expansion that sufficiently differ from one another such that physical contact cannot easily be maintained over the entire operating temperature range.

In particular, for a typical design of resonator 100 in which the coefficient of thermal expansion of the metal housing is greater than that of the dielectric insert, a configuration of elements that provides good physical contact at a relatively low temperature may result in an air gap between the dielectric insert and the metal cover at a relatively high temperature, which air gap will prevent resonator 100 from operating properly in its desired resonant frequency, since the metal housing expands with rising temperature faster than the dielectric insert. On the other hand, a configuration of elements that provides good physical contact at a relatively high temperature may result in the dielectric insert breaking (e.g., cracking) at a relatively low temperature, due to the increased compressive forces applied by the metal housing at low temperatures, since the metal housing shrinks with falling temperature faster than the dielectric insert.

### SUMMARY

Problems in the prior art are addressed in accordance with the principles of the present invention by including a resilient element to the resonator design to compensate for differences in the coefficients of thermal expansion between the metal housing and the dielectric insert by accommodating for different rates of change in the physical dimensions of certain elements over the operating temperature range.

In one embodiment, the present invention is a dielectric resonator comprising (i) an electrically conductive housing having a top and a bottom, (ii) a dielectric insert located within the housing, such that an annular gap exists between the dielectric insert and the housing, and (iii) a resilient element located between the dielectric insert and either the top or bottom of the housing.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a cross-sectional side view of a conventional TM-mode dielectric resonator;

FIG. 2 shows a cross-sectional side view of a TM-mode dielectric resonator, according to one embodiment;

FIG. 3 shows a cross-sectional side view of a TM-mode dielectric resonator, according to another embodiment; and

FIG. 4 shows a magnified view of the bottom portion of FIG. 3.

### DETAILED DESCRIPTION

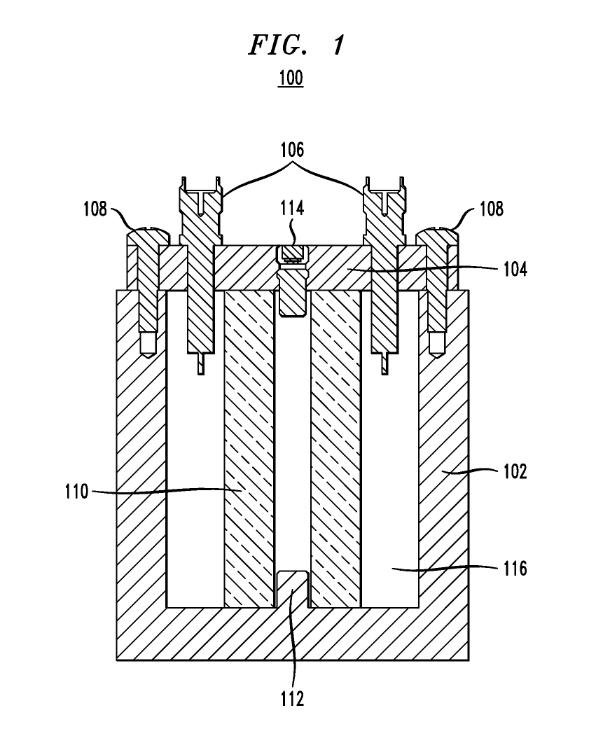

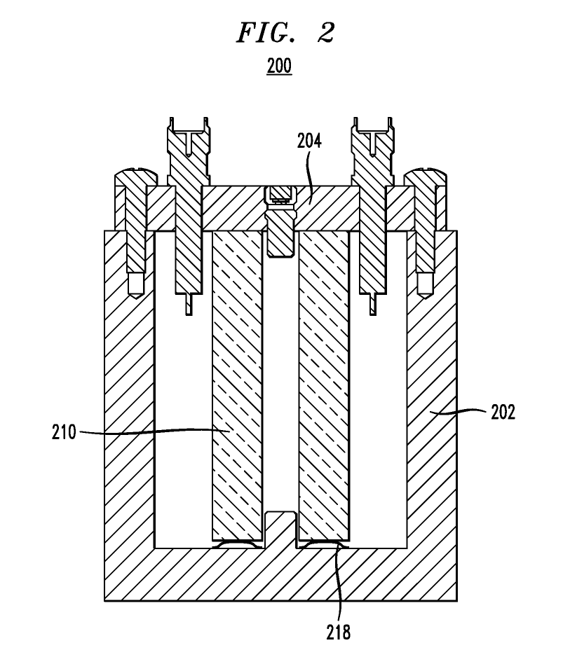

FIG. 2 shows a cross-sectional side view of a TM-mode dielectric resonator 200 according to one embodiment. Resonator 200 is substantially identical to resonator 100 of FIG. 1 with analogous corresponding elements, i.e. the Resonator comprises an electrically conductive (e.g., metal such as aluminum) housing consisting of a cylindrical container 202 and a circular cover 204, configured with two electrical connectors 106, where cover is held in place on the top of container by a number of screws 108. Positioned within resonator is a hollow, cylindrical dielectric insert 210, which is centered within resonator using a cylindrical guide pin 112 located at the bottom of container. Tuning screw 114 is provided to tune the resonant frequency of resonator 200; the outer diameter of dielectric insert 210 is smaller than the inner diameter of cylindrical container 202, such that resonator 200 has a cylindrical, annular gap between insert 210 and container 202, except that resonator 200 has an electrically conductive (e.g., metallic) spring washer 218 positioned between the bottom of metallic container 202 and the lower end of dielectric insert 210. Spring washer 218 is designed (or selected) and resonator 200 is configured such that good physical contact is maintained (i) between metal cover 204 and the upper end of dielectric insert 210, (ii) between the lower end of dielectric insert 210 and spring washer 218, and (iii) between spring washer 218 and the bottom of container 202 over the entire operating temperature range of resonator 200.

In particular, at the low end of the operating temperature range, at which the height of container 202 is at its smallest value, spring washer 218 will be in its highest compression state for resonator 200. At the high end of the operating temperature range, at which the height of container 202 is at its largest value, spring washer 218 will be in its lowest compression state for resonator 200. Note that, spring washer 218 is specifically designed (or selected) such that, in it highest compression state, spring washer 218 will not apply compressive forces sufficient to break dielectric insert 210, while, in its lowest (albeit preferably non-zero) compression state, spring washer 218 will still ensure good physical contact throughout resonator 200.

In this case, a contiguous, electrically conductive path is provided from the lower end of dielectric insert 210 to the upper end of dielectric insert 210 via spring washer 218, container 202, and cover 204.

In an another not disclosed embodiment, the resonator 200 has an electrically conductive spring positioned between the bottom of metallic container 202 and the lower end of dielectric insert 210.

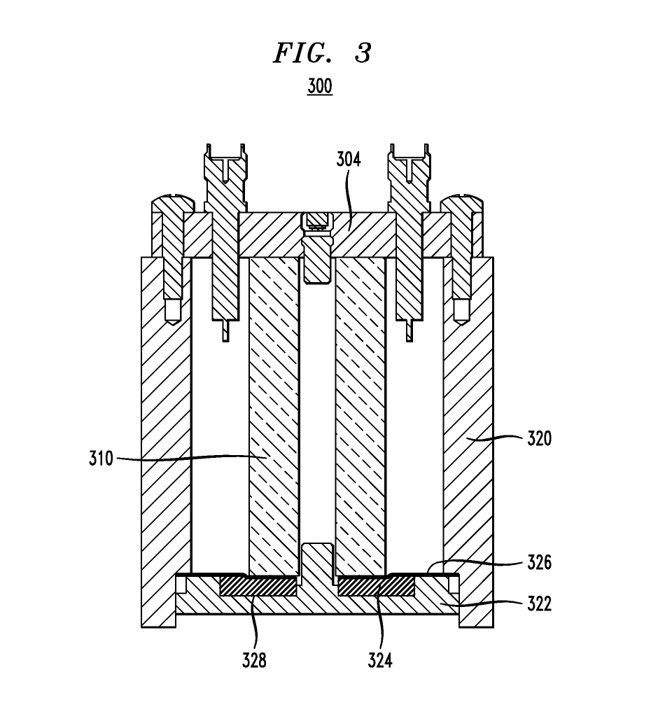

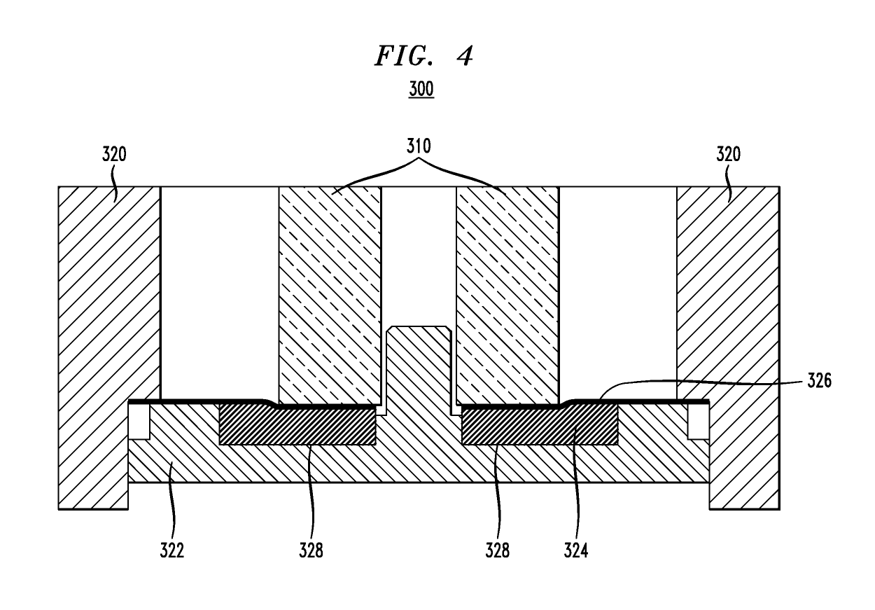

FIG. 3 shows a cross-sectional side view of a TM-mode dielectric resonator 300 according to another embodiment. FIG. 4 shows a magnified view of the bottom portion of FIG. 3. Resonator 300 is substantially identical to resonator 100 of FIG. 1 with analogous corresponding elements, except for the following.

Instead of having a container formed from a single piece of metal, as in container 102 of FIG. 1, the container of resonator 300 is formed from (i) a hollow, cylindrical, electrically conductive (e.g., aluminum or other metal) tube 320 having a tapped bottom opening and (ii) a threaded, circular, electrically conductive (e.g., aluminum or other metal) end cap 322 that screws into the tapped bottom opening of tube 320. Positioned between the lower end of dielectric insert 310 and end cap 322 is a resilient, annular gasket 324.

If gasket 324 is made of an electrically conductive material (e.g., ultra-flexible Cu/Be), a contiguous, electrically conductive path is provided from the lower end of dielectric insert 310 to the upper end of dielectric insert 310 via gasket 324, end cap 322, tube 320, and cover 304.

If gasket 324 is made of a electrically non-conductive material (e.g., silicone rubber), then resonator 300 includes a thin, annular, electrically conductive (e.g., metal) plate (e.g., aluminum foil) 326 that extends from (i) functioning as a physical interface between the lower end of dielectric insert 310 and the top side of gasket 324 at the inner radial dimension of the plate to (ii) functioning as a physical interface between tube 320 and end cap 322 at the outer radial dimension of the plate. In this way, a contiguous, electrically conductive path is provided from the lower end of dielectric insert 310 to the upper end of dielectric insert 310 via plate 326, tube 320, and cover 304. Note that, even if gasket 324 is itself electrically conductive, resonator 300 can still include plate 326 in its design.

In either case, gasket 324 is designed (or selected) and resonator 300 is configured such that:

At the low end of the operating temperature range, at which the height of tube 320 is at its smallest value, gasket 324 will be in its highest compression state for resonator 300; and

At the high end of the operating temperature range, at which the height of tube 320 is at its largest value, gasket 324 will be in its lowest (albeit preferably non-zero) compression state for resonator 300.

Note that, gasket 324 is specifically designed (or selected) such that, in it highest compression state, gasket 324 will not apply compressive forces sufficient to break dielectric insert 310, while, in its lowest compression state, gasket 324 will still ensure good physical contact throughout resonator 300. Note further that, as represented in FIGS. 3 and 4, throughout the operating temperature range, the thickness of gasket 324 is greater than (or at least equal to) the depth of annular recess 328 in end cap 322 in which gasket 324 resides, such that gasket 324 will always extend above (or at least never fall below) the upper surface of end cap 322.

In one possible implementation, resonator 300 is assembled by:

Placing gasket 324 within recess 328 in end cap 322;

Placing plate 326 over the gasket/end cap assembly;

Screwing the plate/gasket/end cap assembly into the bottom of tube 320;

Inserting dielectric insert 310 into the end cap/tube container assembly; and

Mounting cover 304 onto the top of the insert/container assembly.

Note that mounting cover 304 onto the top of the insert/container assembly at an intermediate temperature within the operating temperature range (e.g., 25 C room temperature) results in gasket 324 being compressed to an intermediate compression state for resonator 300 relative to the highest and lowest compression states associated with the lowest and highest temperatures, respectively, in the resonator's operating range.

Although embodiments have been described in the context of dielectric resonators in which a resilient element (e.g., spring washer 218 of FIG. 2 or gasket 324 of FIG. 3) is located between the lower end of the dielectric insert and the bottom of the container, in alternative embodiments, a resilient element is located between the upper end of the dielectric insert and the top cover, either instead of or in addition to the resilient element located at the bottom of the resonator. When the dielectric resonator has two resilient elements, one at its top and the other at its bottom, those resilient elements may be the same (e.g., two metallic spring washers or two silicone rubber gaskets) or different (e.g., one metallic spring washer and one silicone rubber gasket).

Although the container of resonator 300 of FIGS. 3 and 4 is formed from two elements (i.e., tube 320 and end cap 322), in alternative embodiments, the container is made from a single piece of material, as in resonators 100 and 200 of FIGS. 1 and 2. In this case, when the gasket is made from an electrically non-conductive material, some appropriate means is provided to ensure the electrical connection between the thin plate and the container, such as by purposely shaping the thin plate in an appropriate manner.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A dielectric resonator comprising:
an electrically conductive housing having a top and a bottom;
a dielectric insert located within the housing, such that an annular gap exists between the dielectric insert and the housing; and
a resilient element located between the dielectric insert and either the top or bottom of the housing.

2. The resonator of claim 1, wherein the dielectric resonator is a TM resonator.

3. The resonator of claim 2, wherein the TM resonator is a TM01 resonator.

4. The resonator of claim 1, wherein the resilient element is an electrically conductive spring.

5. The resonator of claim 4, wherein the electrically conductive spring is a metal spring washer.

6. The resonator of claim 1, wherein:
the resilient element is an electrically non-conductive gasket; and
the resonator further comprises an electrically conductive plate located between one end of the dielectric insert and the electrically non-conductive gasket, wherein the electrically conductive plate electrically connects the one end of the dielectric insert to the housing.

7. The resonator of claim 1, wherein the housing comprises:
a tube having a top opening and a bottom opening;
a cover mounted over the top opening of the tube; and
an end cap mounted within the bottom opening of the tube.

8. The resonator of claim 7, wherein the end cap is screwed into the bottom opening of the tube.

9. The resonator of claim 7, wherein the gasket is located between a bottom end of the dielectric insert and the end cap.

10. The resonator of claim 9, wherein the gasket is located within a recess in the end cap.

11. The resonator of claim 10, wherein:
the resonator has an operating temperature range; and
the gasket has a thickness that is not less than a depth of the recess over the operating temperature range for the resonator.

12. The resonator of claim 9, wherein further comprising an electrically conductive plate located to provide a first physical interface between the bottom end of the dielectric insert and the gasket and a second physical interface between the end cap and the tube, such that a contiguous electrically conductive path exists from the bottom end of the dielectric insert to a top end of the dielectric insert via the plate, the tube, and the cover.

13. The resonator of claim 1, wherein:
the resonator has an operating temperature range from a lowest operating temperature to a highest operating temperature;
at the lowest operating temperature, the resilient element is at its highest state of compression for the resonator; and
at the highest operating temperature, the resilient element is at its lowest state of compression for the resonator.

14. The resonator of claim 13, wherein the lowest state of compression is a non-zero state of compression.

15. The resonator of claim 1, wherein:
the dielectric resonator is a TM01 resonator;
the resilient element is an electrically non-conductive gasket; and the resonator further comprises an electrically conductive plate located between one end of the dielectric insert and the gasket, wherein the plate electrically connects the one end of the dielectric insert to the housing;
the housing comprises:
a tube having a top opening and a bottom opening;
a cover mounted over the top opening of the tube; and
an end cap screwed into the bottom opening of the tube;
the gasket is located between a bottom end of the dielectric insert and the end cap;
the gasket is located within a recess in the end cap;
the resonator has an operating temperature range from a lowest operating temperature to a highest operating temperature;
the gasket has a thickness that is not less than a depth of the recess over the operating temperature range for the resonator;
the plate is located to provide a first physical interface between the bottom end of the dielectric insert and the gasket and a second physical interface between the end cap and the tube, such that a contiguous electrically conductive path exists from the bottom end of the dielectric insert to a top end of the dielectric insert via the plate, the tube, and the cover; at the lowest operating temperature, the gasket is at its highest state of compression for the resonator; and
at the highest operating temperature, the gasket is at its lowest state of compression for the resonator, wherein the lowest state of compression is a non-zero state of compression.

16. Apparatus comprising a dielectric resonator, the dielectric resonator comprising:
an electrically conductive housing having a top and a bottom;
a dielectric insert located within the housing, such that an annular gap exists between the dielectric insert and the housing; and
a resilient element located between the dielectric insert and either the top or bottom of the housing.
